(19) United States
(12) Patent Application Publication
(10) Pub. No.: US 2007/0200827 A1
(43) Pub. Date: Aug. 30, 2007

(54) METHOD AND MATRIX FOR INPUTTING SYMBOLS INTO COMPUTERS

(76) Inventor: Dmitry Ivanovich Samal, Minsk (BY)

Correspondence Address: BROOKS KUSHMAN P.C., 1000 TOWN CENTER, TWENTY-SECOND FLOOR, SOUTHFIELD, MI, 48075, US

(21) Appl. No.: 11/740,499

(22) Filed: Apr. 26, 2007

Related U.S. Application Data
(63) Continuation of application No. PCT/BY05/00011, filed on Oct. 27, 2005.

(30) Foreign Application Priority Data
Oct. 29, 2004 (BY) A20041008

(51) Int. Cl. G06F 3/02

(52) U.S. Cl. 345/168

(57) ABSTRACT

The invention relates to digital devices, employing a reduced keyboard for text entering. The technical effect of the invention is solving ambiguity of depressed key sequence by using disambiguation system at character level, minimizing a number of entered keystrokes, raising efficiency of inputting both broadly used and special characters of various languages and enabling a user to enter texts by using a touch typing system. Characters 5 of the alphabet are divided into groups 21, 22, 23, depending on its frequency of occurrence in the actual texts. Any character 5 of group 21, comprising “high-frequency” character, is entered by one key-press. As for characters of other groups 22, 23, it is required to select a relevant group 22 or 23, first, and then select a character 5 of same group. Depending on a number of characters in the alphabet and keys on the reduced keyboard, the character groups are split to multiple subgroups 24 (comprising 2-3 characters each). The images of characters 5 of groups 21, 22, 23 are displayed on the screen 3 adequately to topology of key layout of the reduced keyboard 1, allocated to said characters 5. When switching over to group 21, 22, 23, the images of characters 5 are simultaneously modified. The arrangement of characters 5 of the selected language on keys of the reduced keyboard 1 within each group 21, 22, 23 is carried out based on the technology of utmost layout matching to topology of the conventionally adopted layouts of the complete computer keyboard employed for the relevant language. The matrix 20 is designed to arrange the selected language characters, referred to one group (subgroup), on the fields of group 21, 22, 23 (subgroup 24) congruently to topology, their geometrical location on the complete computer physical keyboard, for example, PC keyboard. The matrix 20 may have an alternative embodiment, for example, with reference to FIG. 10, which displays both mathematical 27, and letter 5 characters of a randomly selected language. The drawing on FIG. 1 is attached to accompany the abstract.

### CROSS-REFERENCE TO RELATED APPLICATIONS

This is a continuation of International Application No. PCT/BY2005/000011, published in Russian, with an international filing date of Oct. 27, 2005, which claims priority to BY a20041008, filed Oct. 29, 2004.

### FIELD OF THE INVENTION

The invention relates to technologies for programmable digital devices having every one or some of the following capabilities: input, processing, storage, transmission, symbolic information representation. Input and processing, in this case, is achieved by means of physical or virtual keyboards (simulated by software-program on the device display). The computers of all classes, like cellular and conventional telephones, calculators, electronic palm organizers/notepads, electronic translators, remote control means for various devices (players, television sets, electronic adapters) in combination with the said devices, cash banking terminals, CD- and MP3-players and recorders, and other devices, decoding keystrokes of physical or virtual keys depressed to input or obtain the symbolic information from the user may be referred to such means.

The invention relates more specifically to the limited operational resource systems, which have a reduced keyboard and/or a limited memory capacity.

### PRIOR ART

The most known method of inputting the symbolic information (hereinafter referred to as “text”) into a programmable digital device is based on using a complete alphabet keyboards, like ones, which have each alphabetic character associated with a particular physical key. In other words, as the particular physical key is depressed, one symbol (or character), strictly fixed with a selected language, may be entered only. By the language alphabet symbols here and hereinafter are implied characters, blank space, full point, comma and other major punctuation symbols per se, and the auxiliary symbols, featuring the written representation of sentences in the selected language, for example, “ [symbol] ” and “ˆ” symbols in the French language, or “ [symbol] ” and “i” in Spanish.

However, in case of inputting text into a digital device having the reduced keyboard, the allocation of an individual key to each alphabet character is obviously not always possible, as the number of physical keys is less, than that of symbols for the required language. A standard digital keypad of the mobile telephone, for example, has 12 physical keys, 3-5 keys may be additionally employed (depending on a particular design), whereas Palm-type computers have total 5 to 7 keys. In similar cases there is an ambiguity of matching device physical keys and the alphabetic symbols.

The problem of character entry by means of the reduced keyboards continues to be challenging, and it is proved by auxiliary physical devices, specially designed for text entering and normally connected to resource-limited devices such as mobile telephones, pocket computers, communicators, etc., which are regularly emerging in the market They, as a rule, contain an extra set of physical keys, and some of them even have a complete alphabet keyboard and enable the user to input and edit text efficiently enough.

Their major disadvantages are a comparatively high cost, inconvenience of connection, extra weight and overall dimensions of devices. They are not in great demand, as compared to the device and methods for text entry referred to below.

Numerous scientific works, related to a problem of disambiguation of character entry when using the reduced keyboards, were published. One of the most known is “Probabilistic Character Disambiguation For Reduced Keyboards Using Small Text Samples”, an article written by John. L. Arnott and Mohammed. Y. Javed, hereafter referred to as “Arnott article” [1]. The said article gives review and makes study of most known approaches to and embodiments of resolving the character input disambiguation in the English language. They teach that to input one character it is required to depress once or several times the physical key, which is allocated to same character to be entered. A number of keystrokes correspond to a position of the input character in a character array which are allocated to the relevant key. An article studied four ways of allocating characters to physical keys (character layout) in order to define the most effective system. One of them, namely the character allocation to physical keys in an alphabetic order is recognized as most ineffective among four studied cases in the article. However, namely the said method of character allocation to physical keys is applied in the mobile telephones, which are considered to be most distributed devices with the reduced keyboard. This fact is attributed to universality of the indicated layout for various languages, using the Latin alphabet, as the remaining methods of layout pattern depend on the special features of a particular language.

In case of requirement to use characters of two languages, for example, English and Russian, one key of the device may be allocated to 6-8 alphabetic characters of two languages. It is the most disadvantageous case, which has no mechanism implemented for switching the language layout. To select a correct character in similar case, the user has to tap the device physical key once or 7 times (and in case of random error, even more) to track a sequence of characters, proceeding to correct one. Such technique is called “Multitap”, which literally means “multiple keystrokes” as translated from English, which, “de facto”, is a standard and broadly used method for mobile telephones. Its major disadvantage is a multiple “tapping” on physical keys to input one character, and, as a consequence, low input efficiency and intricate usage.

Arnott article surveys also other different methods of disambiguation solutions, which imply using an approach of probable frequency of occurrence of monograms (individual characters), di-grams (two-character grams), tri-grams (tree-character grams) and whole words. In particular, the systems of disambiguation at word level by using dictionaries are noted. The conclusion derived in Arnott article is the thesis about the perspectiveness of development of disambiguation methods namely at character level.

Nevertheless, the systems employing word-level disambiguation methods by virtue of various reasons, broadly prevailed in practice. First similar systems were disclosed in the patents [2,3,4]. They provided for inputting all characters, allocated to particular key, at one press of the same key, fully completing word input by depressing “*” key and decoding the resulting character sequence by the computer through looking up in the dictionary and using special algorithms. The differences were in characters, allocated to keys “1”: “Q”, “Z” in the first cited patent, “Q”, “Z” and “'” (apostrophe) keys in a second cited patent, and “Q”, “Z”, and some “random” character in the third cited patent, accordingly.

The most acknowledged input technique, efficiently solving text entry problem by using a word level disambiguation system, is T9™technology. The device, applying it, and method of text entering by using the same are protected by the patents [5-8].

The said technique is based on using dictionary of the language, selected by the user, and applying the processor of a computing device for automatic checking with the dictionary probable combinations of all characters, allocated to keys pressed by the user, in order to determine a most probable correct word. It is namely the system that attempts to select a required word from several probable predictions, congruent with various combinations of characters marked on the depressed keys and, thus, saves the user from keying load of multiple keystrokes to type in a correct character the user needs. “T9™” system enables to enter easily the text consisting of words, available in the dictionary, to raise input, and, consequently, overall efficiency of performing similar tasks, for example, like typing SMS (Short Message Service) text messages on mobile telephone keypad.

The known technology has inherent disadvantages derived from a limited vocabulary volume. In case of ambiguous recognition of an entered word decoded by the system, the user needs to select one of several words, retrieved by the program. For short words of 3-5 characters, a number of predictions may exceed that of characters in a word. If a word, entered by the user, is not on the prediction menu list and, consequently, not available in the vocabulary, the user is prompted to enter a word by the standard way, i.e. typing a sequence of word letters by searching, partially or fully, through all the characters, allocated to key.

As the capacity of accessible memory of the mentioned digital devices is increased, limitations to the physical size of T9™system vocabulary may be lifted partially or completely, nevertheless, the time required for exhaustive sorting-out of a number of word predictions, magnified in the arithmetic progression, which words may be built from the whole set of characters, allocated respectively to keys depressed by the user will be increasing. Yet another disadvantage revealed is incapability to input the majority of proper names, abbreviations, technical terms and other categories of the text information. The statistically reliable passwords neither may be logged in by applying the same method. The memory capacity limitations of devices do not allow to use vocabularies of more or less determined number of languages, that makes it impracticable also in certain cases. Even if the device has sufficient memory space for storing the dictionaries of all languages of the world, the user is able to take advantage of no more than two of them, as it is complicated, as a rule, to scribe alphabetic characters of more than two languages at a time on target keys of the device. To employ the text entering system for any third language the user will have to resort to a substitutive keyboard or to learn by heart alphabetic characters allocation of the relevant language on the keys of the device, what might not be always easy.

The methods of applying the character level disambiguation systems, known in the art at the time Arnott article was written, were reduced to various alternatives of layout (or depiction) of the English alphabetic letters on 12-key telephone keypads and sequences of key presses to select a correct character out of two or three characters, which a particular key is allocated to. The patentability changes, incidentally, were concerned, more than often, only with alternative embodiments of character layout just on one key. The additional techniques of input accuracy still were applied, such as key double clicking or same-depressed-key holding for some period of time.

The character input via different shift keys, i.e. capital and lower case characters, was disclosed in the patent [9]. “1” key was allocated to “Q”, “Z” and “space” characters, the remaining keys represented characters which were grouped by three letters each in the alphabetic order (e.g. “2” key was allocated to ABC, “3” key to DEF, etc. To type in “Q”, it was required to press twice “1” key first, and then “#” key; to key in “Z”, “1” key had to be depressed three times, first, and then “#” key-press followed, to input “space”, “1” key to be depressed four times, first, and then “#” key. To input lower case characters, the following keying sequence was suggested: depress twice “1” key first for generating “q”, and then “*”, for generating “z”, depress <<1>> key three times and “*” key once.

Summarizing the above-said, three core subject matters, which are applied one way or another for entering text into electronic computing devices (ECDs), may be defined as follows: language character layout, matrix for inputting characters and character input method. By a character layout for a certain language is assumed an order or a rule of alphabetic character arrangement for the relevant language on the fields of matrix applied for input process. By an input matrix may be implied spacious relative positioning of elements on a plane defined as matrix fields for the purpose of optimization of various device characteristics. Using the introduced definitions, character input method may be worded as a certain sequence or an algorithm of using character input matrices and character layout matrices for text entering into the devices.

It is worth noting, that an input matrix design, as a rule, is associated with that of a device keypad or keyboard. A matrix design is known, for example, in the art [10], to input characters into a personal computer by using key computing devices, which design comprises a visual line representation on ECD screen or on a hard printed medium of letter and/or digital characters of a text message of the launched language, and a visual representation of letter and/or digital characters on keys of the ECD physical keyboard or keypad [11]. A disadvantage of the matrix in question, in case text is entered into digital devices through a reduced keyboard, is the requirement of allocating an individual key to each alphabetic character, i.e. reserving an individual matrix field for each alphabetic character, what is not always possible, as the number of physical keys available is less, than that of characters of the relevant language. The matrix design, described in

Arnott article, which defines a regular 4-array-by-3-column pattern, is used, therefore, more often for the mobile telephone. Some models of mobile telephones use other matrices, for example, circular-shaped (Nokia 3650, Siemens MC60) or arranged in two individual arrays of buttons on sides of telephone screen (Siemens SX1).

Summarizing all the stated above, it may be noted, that methods of input may differ both in keypad layouts used (e.g. cited methods [2, 3, 4]), and in matrices and layouts (for example, techniques of text entering into PC and mobile telephone), and, finally, in principle of matrix applications (for example, “Multutap” and T9™systems). One or several keypad layouts for each of the languages, supported by device, may be equally applied within one input method as well as different matrices, for example, “Multutap” is embodied in Nokia 3650 mobile telephone (using non-typical matrix), and in telephones having 4×3 standard matrices.

The prototype of the invention closest in the art is the method using a character level disambiguation, described in document [12]. It comprises switching an input device to various modes, namely to digit input and to alphabetic character input. According to said method, the characters of the English alphabet are sorted out by three-character (or tri-grams) groups in alphabetic order, but “Q” and “Z” characters, which are entered to one group sharing it with an extra “space” character. Depending on an alternative embodiment, “1” key may be allocated to “A”, “B”, and “C” characters, and also to “Q”, “space” and “Z” characters. In the letter input mode any character of those three associated with digital (from “1” to “9”) keys may be entered by depressing the relevant key and one of three auxiliary keys (“*”, “0”, “#” keys depressed in a preferred embodiment), which generate selection of the relevant character out of a tri-gram (three-letter group). It suffices to depress one of the keys, allocated to a respective digit, for generating same digit in the digit input mode. One keystroke of “*” key switches the device from digit input mode to capital letter input mode, double clicking on same “*” key induces device switching from digit input mode to lower case input mode. The method, protected by the patent, has some operational functions, intended for text editing through certain keystroke sequences. To delete a last-entered character in letter input mode, for example, it is required to double click “*” key, to delete a last-entered word, it is sufficient to press “*” key three times, to delete last-typed digit in digit input mode it is required to tap “#” key, and, finally, to delete all digits typed in the digit input mode, just double click “#” key [12].

A disadvantage of prototype is its sophistication, as user has to keep constantly in mind what is generated by each key-depressing sequence in each particular mode, respectively, that reduces its typing efficiency and brings to frequent error occurrence. In addition, the described input technique may not be employed for other languages, having over 27 alphabetic characters, unless a number of physical keys of the keyboard/keypad is increased.

A standard design of a mobile telephone matrix comprising 4 arrays and 3 columns is, de facto, the closest embodiment, accepted as prototype of an input matrix. It comprises a visual line representation of alphabetic and/or digital characters of a text message for the launched language on keyboard keys of the electronic computing device or on hard printed medium and differs by allocating several characters, generally, three to four, to one field of a matrix [1]. When a prototype matrix is used, it is required to depress once or multiple times a physical key, preset to a respective matrix field, representing a relevant input character to type in one character. A number of key presses correspond to position of a typed character in a sequence of characters allocated to the said field.

Major disadvantage of matrix designs [1] and text input technique, based thereon, [12], assumed as prototypes, is a great number of keystrokes required to be produced on physical keys while inputting one character, and, as consequence, a low input efficiency and unhandiness.

The basic concept of the invention is to provide text entering on the reduced keyboard, to ensure a disambiguating input of a correct character by depressing one key or a shortcut key sequence, and an optimized input of both alphabetic characters of the selected language, as well as punctuation, digit, and special symbols, to provide performance efficiency at minimal requirement to computing operational resources required, in particular to memory capacity, and performance universality for as many launched languages as possible and easy multilingual text typing.

### INVENTION DISCLOSURE

The objective is achieved by using a method of entering characters into electronic computing devices, preferably mobile telephones, cash banking terminals, digital television sets, electronic palm organizers/notepads, electronic translators, which are keyboard-typed, comprising, according to the invention, splitting the characters of the launched language into groups, displaying images of the device keyboard keys on the said device screen during text entering, with a probable unambiguous association emerging between a virtual key and a corresponding physical key of the keyboard allocated thereto, determining unambiguously one-to-one matching between each character of one group and each physical key on the keyboard, at each instant, by displaying an image of the group character on the virtual key or adjacent thereto on the screen of the device.

Under the claimed method a number of key-presses for typing a character from a group is minimized in such a way, that one keystroke only would be sufficient to input characters of high frequency of occurrence.

Under the claimed method the characters of groups are allocated to keys on a reduced keyboard for each launched language congruently with topology of character layout on a conventional computer keyboard for same language.

Under the claimed method switchover between groups is achieved by depressing a single key of the reduced keyboard.

Under the claimed method the character groups are split to subgroups, switchover between groups or subgroups is induced by one key press and, when group or subgroup switching is generated, the character images of a deactivated group or subgroup are replaced by highlighted character images of an activated group or subgroup on the screen. Under the claimed method switchover of groups or subgroups is achieved by depressing different keys, each of them actuates one particular group or subgroup.

Under the claimed method characters of all groups/subgroups may continuously appear on the screen, and, in addition, characters of an activated group may be highlighted by modifying color, brightness or inversion of character or key images during switchover of group/subgroup characters on the screen.

Under the claimed method the images of keys and characters of all subgroups are continuously displayed along the perimeter of closed figures, congruent with topology of keys on the reduced keyboard, the figures are arranged on the screen having different scale, but one center, the character groups are set along the perimeter of figures in such a way as to arrange the characters of high-frequency of occurrence closer to the center of figures, and those of low-frequency of occurrence far apart from the center.

Under the claimed method character groups are arranged along the perimeter of figures in a way to put characters of low-frequency of occurrence closer to a common center of figures and those of high-frequency of occurrence far apart from the center.

Under the claimed method the character groups are arranged for continuous or temporary display along nonclosed lines congruent with topology of keys of the reduced keyboard.

Under the claimed method a mutual substitution of the images of various groups to key images is achieved by arranging the characters of an activated group in such a way as arrange them as close to as possible or as far as possible from the center of figures, or, in case of representing characters along the nonclosed lines, by arranging the characters of an activated group along the top or bottom line.

Under the claimed method representation of character images on the screen according to topology of keys of the reduced keyboard only, omitting display of key images proper, is admitted.

Under the claimed method switchover of an activated group or subgroup is followed by a beep sound, which is produced by a sound unit, connected to the device or which is a constituent of the latter.

Under the claimed method a unique beep sound of particular keynote (tone) and/or a loudness level is allocated to each group or subgroup, which sound is generated at instant the particular group or subgroup is selected.

Under the claimed method each adding of character to the typed text is backed up by a beep sound of particular tone or by sounds, simulating same characters as if being pronounced, which are generated by a sound unit and a synthesizer, connected to the device or which are constituents of the latter.

Under the claimed method the images of characters of an activated group or subgroup are displayed on individual screens, corresponding to each key, thereby the characters of an activated group or subgroup appear only, one character per each screen of the relevant key.

Under the claimed method the images of characters of an activated group or subgroup are displayed on individual screens, corresponding to each key and arranged under transparent keys of the reduced keyboard, thereby the characters of an activated group or subgroup are displayed only, one character per each field of the screen under the relevant key. Under the claimed method images of the characters of a current layout are displayed continuously on a touch panel during the whole process of character input, the images of keys and characters of all subgroups are displayed along the perimeter of closed figures, the figures, having different scale, but one center, are arranged on the screen, the character groups are spread along the perimeter of figures in a way to locate characters of high-frequency of occurrence closer to a common center of figures and characters of low-frequency of occurrence far apart from the center, and input of characters is produced avoiding switching between groups by touching a respective area of the screen, bearing the image of character to be typed.

A matrix, implementing the method of character input into a key electronic computing device, mainly into mobile telephones, cash banking terminals, digital television sets, electronic palm organizers/notepads, electronic translators, comprising a visual line representation on the screen of an electronic computing device or on a paper medium of letter and/or digital characters of a text message of the relevant language is claimed, wherein characters of the selected language, according to the invention, are arranged by groups on the screen and displayed on the key images of the device keyboard or adjacent thereto, or omitting images of key contours, with a probable unambiguous association emerging between a matrix symbol and a physical key on the keyboard allocated thereto, whereby an instant value of (local) matrix representation has an unambiguous correspondence to a representation of, at least, one matrix group, with a probable one-to-one matching being determined between each character of one group and each physical key of the keyboard, by displaying image of the group character on the virtual key or adjacent thereto on the screen of the device (ECD).

According to design, to have the images of keys and characters of all subgroups in a matrix displayed continuously around the periphery of closed figures, congruent with topology of keys on the reduced keyboard, whereby figures, having different scale, but one center are arranged on the screen, the character groups are spread around the periphery of figures in such a way as to have the characters of high-frequency of occurrence arranged closer to a common center of figures, and those of low-frequency of occurrence arranged far apart from the center.

In other words, the method of text entering advanced by the invention distinguishes from those known in the art, firstly, by using another matrix for character input, suggested by the invention, secondly, by a non-conventional application of the said matrix for an electronic computing device, thirdly, by a non-conventional principle of arranging alphabetic characters of languages in the fields of the advanced matrix.

While designing an input matrix according to the invention, the alphabetic characters of the particular language are grouped depending on frequency of occurrence of the character in the real texts and a number of matrix fields in each group. The number of matrix fields depends on an number of keys on a (reduced) keyboard of the device and a number of characters in the alphabet of the language, a mutual layout of matrix fields is arranged to have an unambiguous association emerging between the character of some field and a relevant key of the keyboard of the device when matrix fields are displayed on ECD screen. Depending on the launched alphabet and a number of keys on the reduced keyboard, the character groups may be split to subgroups (2-3 characters per subgroup).

During the process of text entry, the matrix may be displayed on ECD screen fully or partially, therewith either groups or subgroups of characters appear on the screen, in case of a partial display.

The technique is implemented so that any character from the group of frequently occurring characters could be entered by one key-press. Hence, to input characters of other groups, it will be required to select a relevant group first, and then select a character from the same group. Depending on a number of physical keys on the reduced keyboard, a group selection may be produced either by sequentially pressing one particular key, or by holding the same key for particular time, or an individual key for each group may be arranged for switching over to a relevant group. In addition to already-typed text, matrix fields in the form of key images are displayed on the screen. Some matrix fields may remain back-up ones and may not appear on the screen. The virtual key layout on the screen is congruent with topology of physical keys. In particular instant, the characters, which are in the group activated in that very instant, are displayed on virtual key on the screen. The representation of key images with activated characters on, congruent with topology of physical keys on the ECD keyboard, enables the user to enter the correct character. After the character has been typed the “high-frequency” character group becomes automatically activated. In case the character groups are split to subgroups, the user should point at a selected subgroup first, and then select a subgroup character to be typed. The respective images of characters, sorted by subgroups, are indicated in similar way as topology of key layout on the keyboard, which serve to select a character subgroup required for the user.

A preferable alternative embodiment of matrix for major European languages and a conventional mobile telephone keypad is one which comprises characters shared between 3 groups: one comprising 8 high-frequency characters, second one comprising 8 mean frequently occurred characters and third one covering all the remaining symbols. In such case the character of first group is entered by one key-press of the relevant key of the keypad, to input a character of the second group two key presses are required: a key to launch a group, and another key congruent to the character to be typed. To input any character from third group, with least frequency occurred characters, two to four key presses will be required.

In preferable alternative embodiment of the invention, the virtual keys, bearing images of current group characters, are arranged along the perimeter of the screen, and when a current group is switched over, the images of deactivated group characters are replaced by the images of characters of an activated group.

If dimensions of ECD screen are sufficient enough, then, according to another embodiment of the invention, the images of characters, grouped according to frequency of occurrence, may appear continuously on ECD screen. In this case, the characters of groups are displayed around the periphery of a circle, square, polygon or other closed figure congruent with topology of keys on the reduced keyboard allocated to the indicated characters. A figure of a particular scale, which is in direct or inverse relation to an index of groups, corresponds to each group. The centers of figures coincide, i.e., in case of direct relation, the group of “high-frequency” characters is arranged along the perimeter of minimum scale figure, the group having low-frequency characters is arranged around the periphery of a bit-greater-scale figure, which is circumscribing the previous one, etc. In this case “high-frequency” characters are preferably to be arranged closer to the center, common for all figures, than less occurred characters, as the user's sight is focused in the center. More over, the groups of low-frequency characters, as a rule, are more numerous, it is more difficult to arrange them along the perimeter of a nested minimum-size figure, therefore, they are split to subgroups.

In further alternative embodiment of invention, the lines, along which character images of a current group may be displayed continuously or temporarily, may be nonclosed. Nevertheless, they should be congruent with topology of keys on the reduced keyboard allocated to the relevant characters. As a current group is switched over, the relevant characters of an activated group, at the same time, are highlighted, whereas all remaining ones are shadowed by fading out color, reducing intensity (brightness) or inversion of color, black-and-white and monochrome displays, accordingly.

In yet another alternative embodiment of the invention an activated group switchover may be achieved by mutually substituting the images of characters of various groups so that the characters of an activated group would be always arranged as close to center of figures as possible, or, in case of representing characters along the nonclosed lines, the characters of an activated group would be arranged along the top or bottom line, depending on the way of display of character images at a bottom or top region of the screen.

According to the invention, while designing layouts, the allocation of characters to matrix fields within each group for certain language is carried out on the principle of making layouts as congruent as possible to topology of the conventionally adopted layouts for particular language on the complete computer keyboard. So, for example, if “X” character is disposed in the left-hand bottom corner of the complete keyboard, then, while allocating a respective matrix field to same character, the most preferable alternative embodiment will be the field from the left bottom corner of relevant group in respect of somewhat pre-selected matrix center, which coincides, as a rule, with the center of array of keys on the reduced keyboard. Such principle of character allocation to keys provides for easy text entering while using the invention, as the user, who frequently operates devices, having the complete keyboard, would intuitively (automatically) search for the relevant character in the field of screen or a reduced keyboard, corresponding to its arrangement on the complete keyboard (i.e. by analogy with its layout on the complete keyboard). Application of the said principle of character allocation to matrix fields, and, matter-of-factly, to the keys of ECD keyboard, will enable a novice user to learn promptly the input technique, to avoid any tangle with layouts of the reduced keyboard, and, consequently, to reduce a number of errors and time workload to type the relevant character of an activated group.

In a preferable alternative embodiment of the invention switchover between the upper and lower case shifts, i.e. between modes to input capital and lower case letters of the alphabet, is achieved by depressing an extra key which is not used directly for entering characters. One layout comprises, whenever is possible, the characters of one language. The characters, which are not alphabetic, such as punctuation marks, numeric, currency and other nonalphabetic characters, are joined into one or several specific layouts. The switchover of layouts is produced as follows: before text entering the user connects or activates the layouts which might be needed from those available in the design of a particular ECD, the user switches over from a current layout to the next one, selecting it from an on-line layout list, by depressing the relevant key during text entering, when the last-on-the-list layout is reached, switchover to the first (initial) layout is achieved after depressing the indicated key.

In case the device, for which the invention is used, is supplied with individual screens for each key or the keys are made of a transparent material and are arranged atop of the screen, the character images of an activated group/subgroup are represented on the screens, respective to keys, or on the screen surfaces under the relevant keys.

In case a keyboard and a screen represent one combined device, e.g. a touch panel, the invention consists in application of a novel advanced input matrix, i.e. in another alternative of representing alphabetic characters, as distinguished from ordinary display of the complete alphabetic keyboard or sorted out by the alphabet letter characters on the screen. They are grouped by “frequency of occurrence” of the language characters and according to the principle of utmost character position similarity of a group character layout to topology of the conventional layouts adopted in the complete computer keyboard for the relevant language, as mentioned above. There is no requirement, in this case, to select an activated group, and any character of a current layout may be typed at one touch on the relevant area of the screen.

To enable the user to type text not looking at the screen, all the alternative embodiments of the method allow switchover from one activated group or subgroup to another, which is followed by a beep sound, produced by a sound unit, connected to the device or which is a constituent of the latter. A unique beep sound of particular keynote (tone) and/or volume level is allocated, therewith, to each group or subgroup, which is produced at instant the particular group or subgroup is selected. To confirm input of correct characters for eye-sight-disabled users it is advantageous to backup a typed character by a beep of particular tone or by synthesized sounds, simulating the selected alphabetic character or character title as if being pronounced, which are generated by a sound unit and a synthesizer, connected to the device or which are constituents of the latter. Hence, the invention allows typing characters by using a touch typing system as distinguished from all previous methods, known in the art, used for text entering into ECDs, having a reduced keyboard.

The technical effect of the invention is in achieving character-level disambiguation of entered keystrokes, in minimizing keying workload, in raising character input efficiency both for broadly used alphabetic characters, and specific characters of various languages and nonalphabetic ones and in enabling text entering by using a touch-typing system, if the user has adequate skills.

For better understanding, the invention is accompanied with the drawings, wherein:

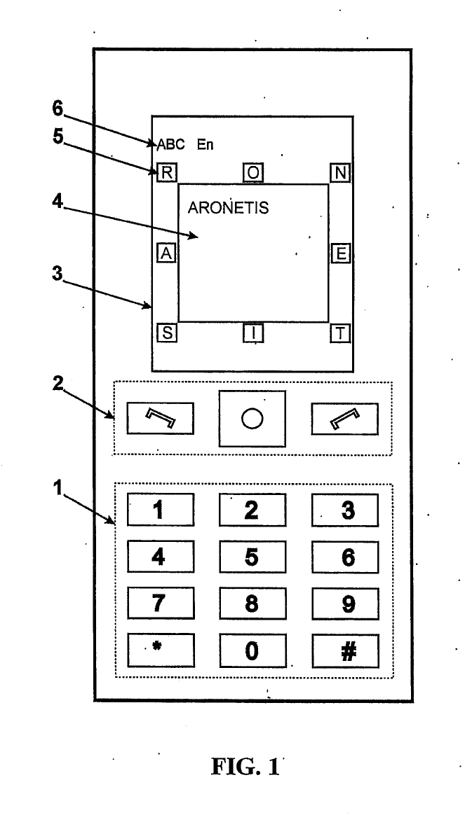

FIG. 1—a schematic view of a preferable alternative embodiment of the invention, a pattern of an on-the-screen character arrangement of a “high-frequency” character group (one of layout probable alternatives for the English language);

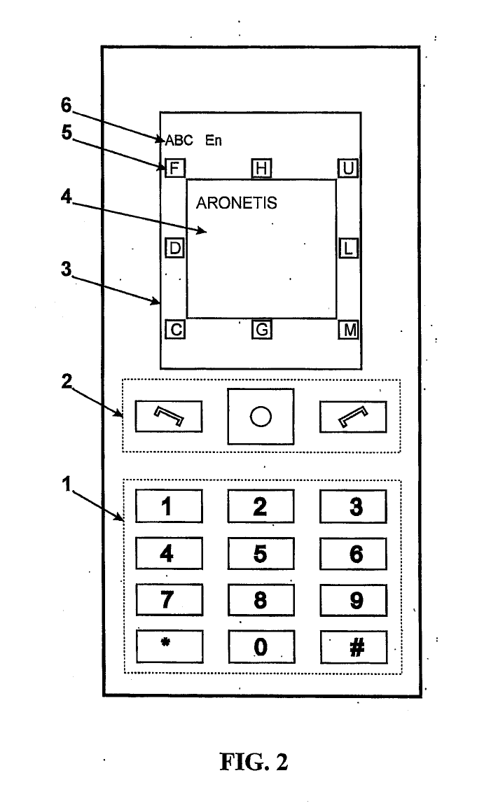

FIG. 2—a pattern of on-the-screen character arrangement of a second group, activated in very instant, for the English language (one of layout probable alternatives for the English language) in a preferable alternative embodiment of the invention;

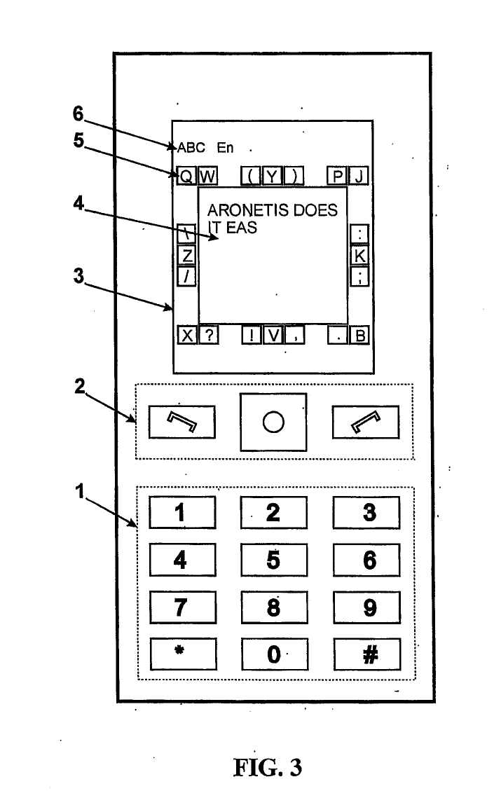

FIG. 3—a pattern of on-the-screen character arrangement of <<low-frequency>> character group, split to subgroups (one of layout probable alternatives for the English language);

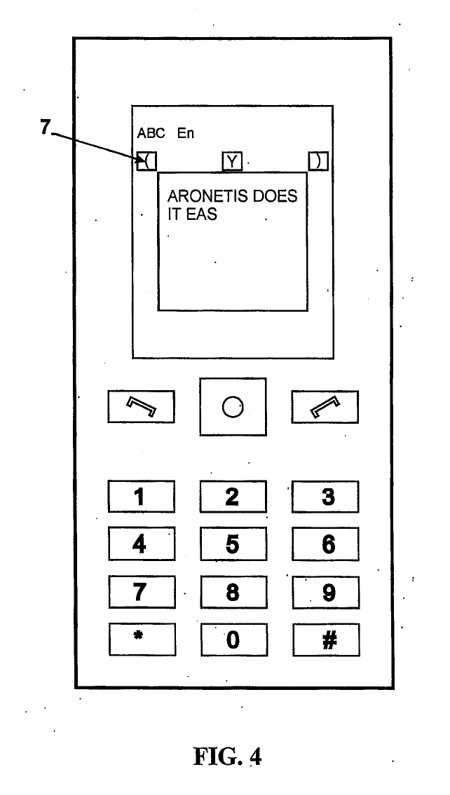

FIG. 4—a pattern of on-the-screen character arrangement of the subgroup, selected by the user (one of layout probable alternatives for the English language) in a preferable alternative embodiment of the invention;

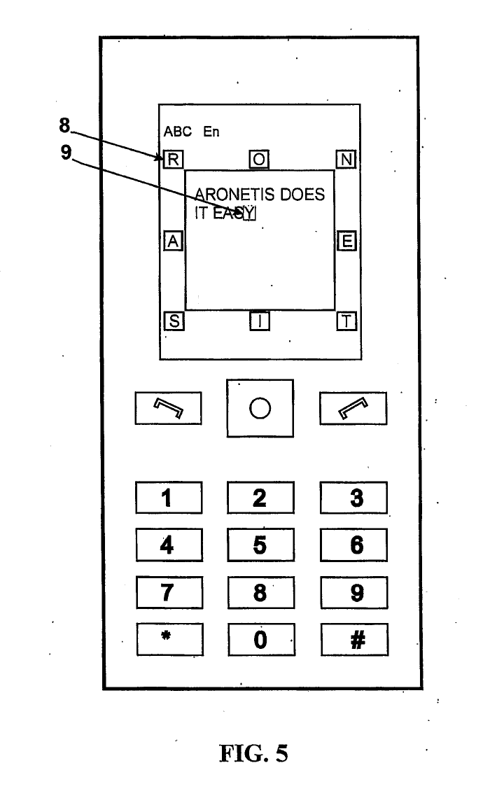

FIG. 5—a result of “Y” character input and a pattern of on-the-screen character arrangement of a “high-frequency” character group, which became reactivated, a preferable alternative embodiment of layout for the English language;

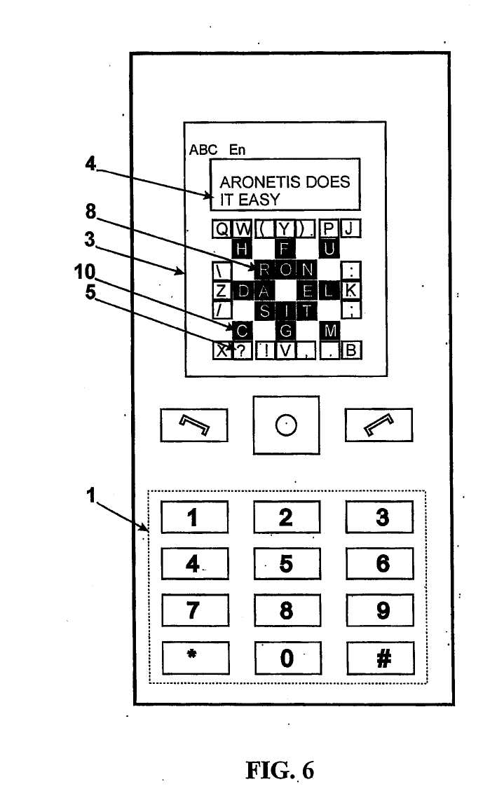

FIG. 6—a pattern of probable on-the-screen character arrangement of all three groups simultaneously for one of probable layouts for the English language;

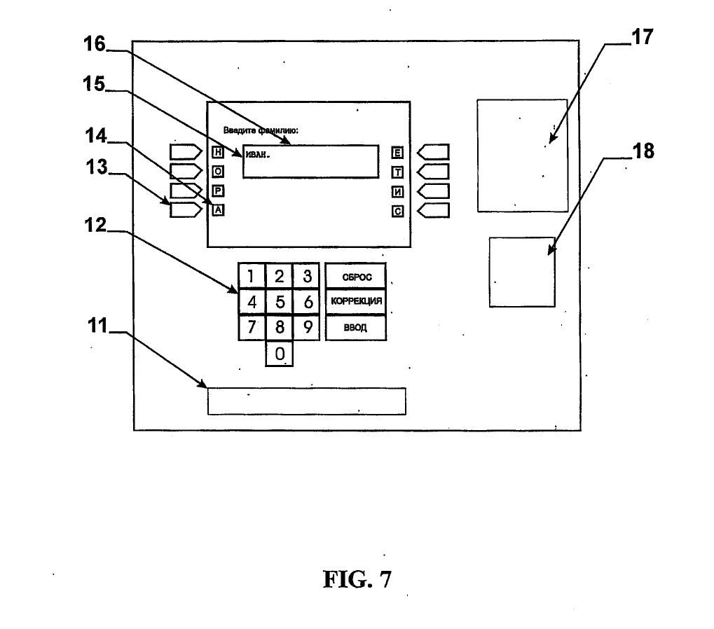

FIG. 7—a pattern of probable alternative embodiment of the invention for cash banking terminal, Russian text entering mode activated by using a suggested technique;

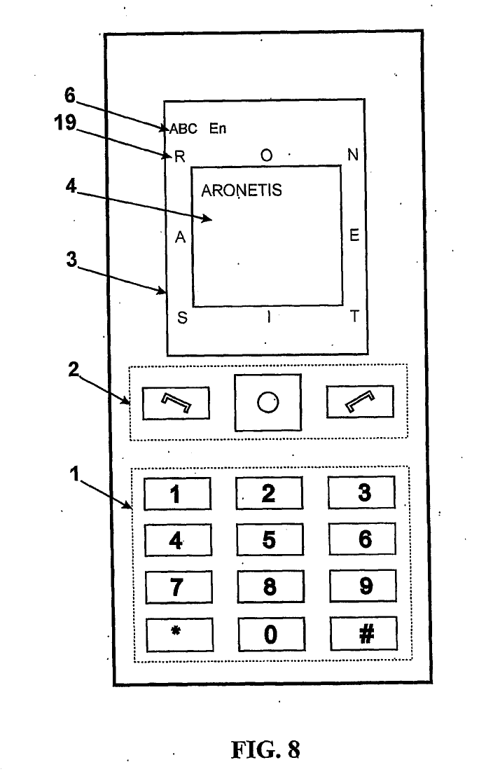

FIG. 8—a pattern of probable performance, key images (matrix fields) are not displayed on the screen, character images of an activated group are represented only;

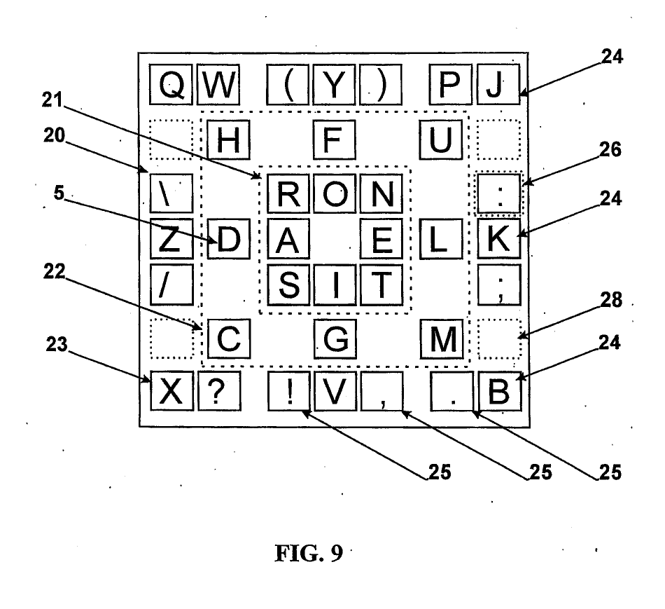

FIG. 9—a schematic view of matrix design, a pattern of character arrangement of the English language on the screen or paper medium (one of probable matrix alternative embodiments for the English language);

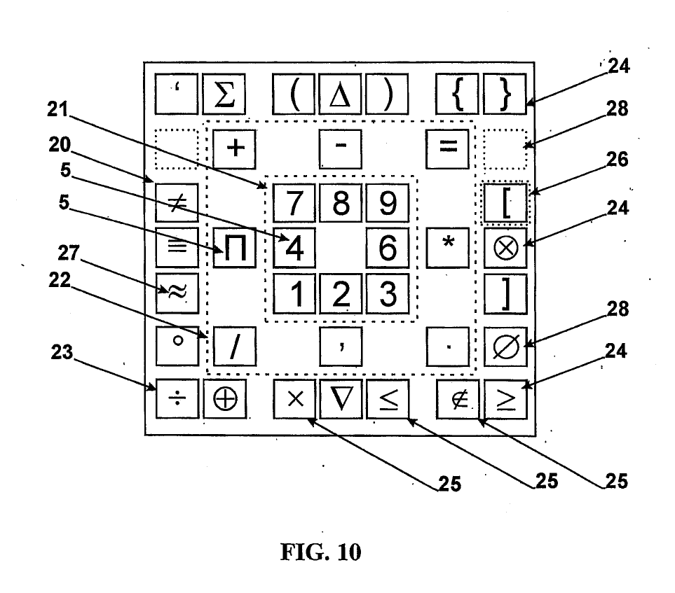

FIG. 10—a schematic view of matrix design, a pattern of arrangement of numerical, nonalphabetic and/or alphabetic characters on the screen or paper medium (one of probable alternative embodiments of a matrix).

The way how method is implemented is shown by referring to example of character input into an electronic computing device, mainly, into a mobile telephone.

### THE PREFERRED EMBODIMENT OF THE INVENTION

A pattern of device in pursuance of the invention is implemented via its alternative embodiments fulfilled according to the drawings, wherein FIG. 1 shows the device, having the character layout of most frequently employed group, which comprises the preferable numeric keypad 1 of a mobile telephone, auxiliary keys 2, screen 3 of the same mobile telephone, area 4 representing the typed text, key images 5 bearing images of characters of an activated group, displayed according to layout of “1”, “2”, “3”, “6”, “9”, “8”, “7”, “4” keys of the numeric keypad of the mobile telephone in respect of “5” key (round the circle or along the perimeter of a rectangle), a command (or status) line 6 of the typed text is reduced: “shift” (ABC—capital letters, abc—lower case), an activated layout (“En”—the English language).

The pattern of on-the-screen layout of the second character group of the English language, on-the-spot activated (one of layout probable alternatives for the English language), shown on FIG. 2, in the preferable embodiment of the invention comprises elements numbered 1-6, identical to those of the device on FIG. 1.

Further pattern of on-the-screen layout of characters of “low-frequency” group, split to subgroups (one of layout probable alternatives for the English language), shown on FIG. 3, comprises elements numbered 1-6 identical to those, shown on FIG. 1.

Pattern on FIG. 4 of on-the-screen layout of characters of the subgroup, selected by the user, (one of layout probable alternatives for the English language) in a preferable alternative embodiment of the invention comprises elements numbered 1-6 identical to those on FIG. 1, and key images 7 and characters of a selected subgroup, congruent with topology of “1”, “2”, “3” keys of the numeric mobile telephone keypad 1.

Pattern of on-the-screen layout of characters (FIG. 5) is carried out by introducing “Y” extra character and simultaneously representing on the screen the layout of characters of a reactivated “high-frequency” character group, a preferable alternative embodiment of layout for the English language, it comprises elements numbered 1-7 and images of keys 8 and characters of “high-frequency” character group, represented in similar way as topology of “1”, “2”, “3”, “6”, “9”, “8”, “7”, “4” keys of the mobile telephone numeric keypad, and result 9 of the character input.

The pattern (shown on FIG. 6) of probable arrangement of characters of three groups simultaneously on the screen 5 according to one of probable layouts comprises elements numbered 4,5 identical to those on FIG. 1, element numbered 8 identical to same one, shown on FIG. 5, and key images 10 and characters from a “mean-frequency” group, displayed according to topology of “1”, “2”, “3”, “6”, “9”, “8”, “7”, “4” keys of keypad 1.

Further alternative embodiment of the invention for a cash banking terminal, shown on FIG. 7, having on-the-screen character layout 5, with the mode of text entering in the Russian language as in the claimed invention, comprises cash release gap 11, major key layout 12 of a cash banking terminal, banking terminal auxiliary keys 13, on-the-screen images of characters 14 of an activated (first) character group of the Russian language, banking terminal screen 15, area (or command line) 16 to represent the typed-in text, check release gap 17, banking card push-in/pull-out gap 18.

Pattern of probable layout of characters 19 on the screen 5 (as shown on FIG. 8) of an activated group for one of probable layout for the English language, not displaying the images of keys, comprises elements numbered 1-4,6 which are identical to ones of FIG. 1.

Matrix 20 on FIGS. 9 to 10 for input of characters 5 into keyboard ECDs, mainly into mobile telephones, cash banking terminals, digital television sets, electronic palm organizers/notepads, electronic translators, comprises a visual line representation of alphabetic and/or numeric characters of text message of the selected language on an ECD screen or paper medium. Characters 5 of the selected language may be arranged on the screen or paper medium by groups 21, 22, 23 and subgroups 24 and displayed on the screen on the key images of the device keyboard or aside thereto, or omitting display of key contours 25, with a probable unambiguous association emerging between matrix character 5 and a corresponding physical key of the keyboard allocated thereto, whereby an on-the-spot value of (local) representation of matrix 20 has an unambiguously corresponding representation of, at least, one of groups 21 to 23 of matrix 20, providing a probable unambiguous determination of one-to-one matching of each character of groups 21 to 23 or characters of one subgroup 24 with each physical key of the keyboard 1, respectively, by representing an image of character of one of groups 21 to 23 on the virtual key image or adjacent thereto on the screen of device 3. Matrix 20 comprises fields 26, which, depending on the launched language and computing device capabilities to display matrix 20, may be filled out with character indications or remain stand-by ones, having no implied indications 28. The matrix is logically shared, for example, between group 21 (“A”, “R”, “O”, “N”, “E”, “T”, “I”, “S” characters) of internal contour of FIG. 22, group 22 (“D”, “H”, “F”, “U”, “L”, “M”, “G”, “C” characters) intermediate contour of FIG. 9 and group 23 (“Z”, “\”, “Q”, “W”, “(”, “Y”, “)”, “P”, “J ”, “:”, “K”, “;”, “B”, “.”, “,”, “V”, “!”, “?”, “X”, “/” characters) of peripheral outline, which may comprise a subgroup of fields 24 (“/Z \”, “QW”, “(Y)”, “PJ”, “:K;”, “B.”, “,V!”, “!X”

Matrix 20 was designed according to configuration pattern of keys on the physical keyboard of the device, which it is intended for, for example, mobile telephones, cash banking terminals, digital television sets, electronic palm organizers/notepads, electronic translators.

The matrix 20 was designed to arrange the characters of launched language by groups 21, 22, 23 (subgroup 24) of matrix fields according to their frequency of occurrence in the texts of the relevant language, e.g. characters of “high-frequency” of occurrence (FIG. 9) are arranged in group 21 of the internal contour of matrix design 20.

The matrix 20 is designed to have language characters, referred to one group (subgroup), arranged on the fields of group 21, 22, 23 (subgroup 24), respectively, in such a way as to correspond to the standard topology, e.g. to their geometrical position, for instance, on the PC complete physical keyboard.

The matrix 20 may be adapted, for example, as shown on FIG. 10, to represent both mathematical 27, and alphabetic 5 characters of any natural randomly selected language.

The matrix may, in this case, have design (not shown), for example comprising fragments as on FIG. 10, which may display either numeric or mathematical or alphabetic (as on FIG. 9) characters 5 of any natural randomly selected language.

### EXAMPLE OF MATRIX PERFORMANCE UNDER THE INVENTION

The performance of the matrix is carried out, for example, by inputting characters into an electronic computing device, for example, a mobile telephone.

An alternative embodiment of the matrix 20 in the mobile telephone arrangement is carried out by implementing its drawing alternatives, on which, with reference to FIG. 1, an alternative on-the-screen layout of matrix 20 is shown, representing a group of <<high-frequency>> characters, which comprises a preferable numeric keypad 1 of the mobile telephone, command and auxiliary keys 2 of the same, a telephone screen 3, area 4 displaying the typed-in text, key images 5 representing the images of an activated character group and keys, displayed according to layout of “1”, “2”, “3”, “6”, “9”, “8”, “7”, “4” keys on the numeric keypad of the mobile telephone in respect of “5” key (round the circle or along the perimeter of rectangle), status (command line) 6 of the typed-in text is reduced: “shift” (ABC—Caps case, abc—lower case), an activated layout (En—the English language).

The pattern of using matrix 20 (FIG. 6) having a probable on-the-screen layout 5 of characters on matrix 20, comprising all three groups simultaneously, which may be applied for one of probable layouts of the English language, with having fragments/elements numbered 4, 5, identical to those on FIG. 1, key images 22, identical to those on FIG. 9, and characters from group with mean frequency of occurrence, displayed according to topology of “1”, “2”, “3”, “6”, “9”, “8”, “7”, “4” keys of the numeric keypad of the mobile telephone, and the inverse virtual keys 8.

Thus, referring to FIGS. 6 and 9, the characters 5 of the selected language are divided into groups 21, 22, 23, they represent key images of the ECD keyboard during text entering on the ECD screen, unambiguously inducing an association to emerge between the image of key 25 and a corresponding physical key on the keyboard 1 allocated thereto, determine an unambiguous correspondence between each character 5 of one of groups 21, 22, 23 and each physical key of the keyboard, respectively, at each instant, by displaying the character image 5 of one of groups 21, 22, 23 on the key image 25 or adjacent thereto on the ECD screen.

### Example of Method Best Mode Under the Invention

The alphabetic characters of the selected language are divided, as shown on FIG. 9, depending on their number, at least, to three groups 21, 22, 23. First group 21, depending on frequency of occurrence of characters in the texts of the selected language, comprises eight <<high-frequency>> characters of the alphabet. FIGS. 6 and 9 show that “A”, “R”, “O”, “N”, “E”, “T”, “I”, “S” characters of first group 21 are disposed in a central area of matrix clockwise, “D”, “F”, “H”, “U”, “L”, “M”, “G”, “C” characters of second group 22 are disposed concetrically to characters of first group 21 far apart from center towards periphery clockwise. The remaining characters of the English alphabet, viz “Z”, “Q”, “W”, “Y”, “J”, “P”, “K”, “B”, “V”, “X” are entered into third group 23, and the most required characters of punctuation such as “\”, “(”, “)”, “:”, “;” “.” “,”, “!”, “?”, “/” are introduced here as well. Other characters of punctuation may be entered too (e.g. “-”, “{”, “}”, “'” and nonalphabetic ones, as shown on FIG. 10. To enter text the key images 25 are represented on the screen according to layout of physical keys of the keyboard 1. Input of characters 5 from one of the above indicated groups 21, 22, 23 is produced at each instant, the character images 5 of one of groups 21, 22, 23, activated in the particular moment, on-screen-displayed on images 25 or adjacent to the images of physical keys on the keyboard 1, relevant thereto. Referring to FIG. 1, for example, “A” character of the first group is allocated to “4” key, “R” to “1” key, “O” to “2” key, “N” to “3” key, “E” to “6” key, “T” to “9” key, “I” to “8” key, “S” to “7” key. By depressing the indicated physical keys an input of any character 5 from an activated group of groups 21, 22, 23 is achieved. The typed character 5 is visualized on the screen at an image domain of the typed-in text 4. In case a required character 5 is missing in an activated group, switchover between groups 21, 22, 23 is achieved by single key press of an individual key on the reduced keyboard 1. Referring to FIG. 1, for example, it is “5” key. In this case, switchover of groups 21, 22, 23 is achieved by using principle “from a “high-frequency” character group to a “low-frequency” character group”. It means if first group was activated (“A”, “R”, “O”, “N”, “E”, “T”, “I”, “S” characters), second group comprising “D”, “F”, “H”, “U”, “L”, “M”, “G”, “C” characters becomes activated after depressing the indicated key. Characters 5 from an activated group of 21, 22, 23 are “re-depicted” on the screen on images 25 or adjacent to the images of keys of the physical keyboard 1, relevant thereto. To input a required character 5 of an activated group, it suffices to tap the relevant physical key 1 (FIG. 2), for example, “D” character will correspond to “4” key, “F” to “1”, “H” to “2”, “U” to “3”, “L” to “5”, “M” to “9”, “G” to “8”, “C” to “7”, respectively, in fact, the keys of the physical keyboard “surrounding” “5” key. Input of a corresponding character 5 of an activated group is achieved by depressing the indicated physical keys 1. The typed character 5 is viewed on the screen 3 in an imaged area of the typed-in text 4. After any character 5 of any group 21, 22, 23 has been typed, automatic switchover of an activated group to the first one, i.e. the high-frequency character group 21, is produced. To input any character of third group 23, a group switchover key should be pressed twice (referring to FIG. 1, it is “5” key on keyboard 1). In this case, switchover of an activated group from first 21 to third 23 is achieved and characters of the third group 23 are displayed on the screen 3. As the number of characters of third group is presumably exceeding eight characters, it is divided into subgroups 24 of two to three characters 5 and put the same on the screen 3, joining by subgroups 24, locating subgroups 24 on the screen 3 according to layout allocated in correspondence to subgroup of keys of the physical keyboard 1. Splitting of character groups into subgroups 24 is achieved in such a way, switchover between groups 21, 22, 23 or subgroups 24 is produced by depressing an individual key 1, and, at the same time as groups 21, 22, 23 or subgroups 24 of characters are switched over, the character images 5 of deactivated groups 21, 22, 23 or subgroup 24 are substituted on the screen by character images of one of activated groups 21, 22, 23 or subgroup 24. Hence “4” key (e.g. FIG. 3) will be allocated to corresponding “/”, “Z”, “\” characters from subgroup 24, “1” key to “Q”, “W”, “2” key to “(”, “Y”, “)”, “3” key to “P”, “J”, “6” key to “:”, “K”, “;”, “9” key to “.”, “B”, “8” key to “!”, “V”, “.”, “7” key to “X”, “?”. By depressing any of the indicated keys 1 selection of a required subgroup of characters 24 is achieved, whereby images of all characters 5, not comprised in a selected subgroup 24, are not represented, and said characters 5 of subgroup 24 are displayed on images 25 relevant to the key 1 to which a selected subgroup 24 is allocated to and adjacent thereto keys 1. Referring to FIG. 4, having subgroup 24 selected, which comprises “(”, “Y”, “)” characters, character “(” is displayed on the screen on image of the key, relevant to the “1” key on the physical keyboard 1, by depressing “2” key, “Y” character is displayed on key image 25, allocated to “2” relevant key, and character “)” on image 25 allocated to “3” key. So, depressing any of “1”, “2” and “3” keys brings “(”, “Y”, “)” characters to appear, respectively. The typed character 5 is visualized on the screen 3 in the field 4 representing the typed text, and an activated group is switched over from third group 23 to first one 21, comprising “high-frequency” characters. When depressing any other key (i.e. “4”, “5”, “6”, “7”, “8”, “9”), input of characters 5 is not produced, an activated third group 23 is switched over to first one 21 only. As this takes place, characters 5 of first group 21 are displayed on the screen 3 on images 25 or adjacent to the images of keys on the physical keyboard, relevant thereto, as shown on FIG. 5. Consequently, one key press of relevant key on the physical keyboard is required to input any character 5 from the first group 21, input of any character 5 of the second group 22 requires one key press on “5” key to switchover an activated group and one more keystroke on the relevant key of the physical keyboard 1. To input any character 5 from the third group 23, double keystroke on “5” key is required to switch over an activated group, one keystroke on the relevant key of the physical keyboard 1 to select a required subgroup 24 and one more keystroke of the relevant key on the keyboard to input a required character 5.

In other words, the user needs to produce one key press on the device keypad to input any character 5 from the first group 21, two key presses to input any character 5 from the second group 22 and total four key presses on the physical keyboard 1 to input a character from the third group 23, i.e. the method allows minimizing a number of key presses to input characters from any group in such a way, that it suffices to press one key only to input a maximum (or high) frequency character.

There may be another probable alternative embodiment of the invention which allows, if the number of physical keys on the reduced keyboard 1 is sufficient to achieve key depressing efficiency when typing characters 5 of the third group 23, switching over between groups 21, 22, 23 or subgroup 24 by depressing various keys 1, with each one actuating one particular group or subgroup only.

The preferred alternative embodiment of the invention has “0” key intended for input of “space” character, the <<high-frequency>> character in the majority of languages round the world. By depressing “#” key switching of modes to input capital/lower case characters is achieved. By depressing “*” key switchover of the activated language is achieved, for instance from English to Russian, Belarusian and any other languages, required by the user.

Depressing keys by the way described above, referring to FIG. 5, for example, English text “ARONETIS DOES IT EASY” is typed in Russian with minimum effort “ [symbol] [symbol] [symbol] [symbol] ” (as translated from English). To input the above sentence by using a technique described above, the user is required, in general, to press keys 25 times (one keystroke to input A, R, O, N, E, T, I, S, “space”, O, E, S, “space”, I, T, “space”, E, A, S per each character, two keystrokes to input “D” and four keystrokes to input “Y”) to type 21 characters, that accounts to mean efficiency of 1.19 keystroke for typing one character.

If to compare, the user will be required to generate 46 keystrokes to type the same phrase “ARONETIS DOES IT EASY” by using “Mutitap” method, mentioned above, i.e. mean keying efficiency will account to 2.19 keystrokes per one character. The input of the same sentence by using “T9™” method will be partially impractical, as “ARONETIS” is not a commonly used word and, sequentially, is not available in the pre-set vocabulary. Having pressed eight keys of the physical keyboard, which bear “A”, “R”, “O”, “N”, “E”, “T”, “I”, “S” relevant characters, the T9™-based system will predict a candidate word of “BROODUIS” to enter, if the user finds it incorrect, he/she might proceed via menu to a word correction mode in Multitap, that will require as minimum as 3 key presses, than 8 key presses more to delete the predicted word of “BROODUIS”, followed by 19 keystrokes to enter a required word of “ARONETIS” through “Multitap”, one additional keystroke to insert it into the text, and build remaining words of the sentence “DOES IT EASY” by producing 12 key presses more. It will require of the user total 50 keystrokes, and it accounts to mean typing efficiency of 2.38 key presses per character. It should be noted, to tell the truth, if the user will add the word of ARONETIS to a built-in dictionary, reentry of the small phrase will require 21 key presses only, one per character. However, input of any word, which is not in the dictionary, enhances key-press workload more than two-fold. The input of same small text by using prototype will require 40 key presses, 2-keystrokes per character to type A, R, O, N, E, T, I, S, D, O, E, S, I, T, E, A, S, Y, one key press to input three “spaces” and one key press to switch on the text entering mode. Hence, the mean keying efficiency will account to 1.9 keys per character.

If dimensions of the device screen 3 are sufficiently large, in this case, according to an alternative embodiment of the invention, as shown on FIG. 6, the character images 5, grouped by groups 21, 22, 23 with regard to frequency of occurrence, may be displayed continuously on the screen, as on FIG. 6. When switching over to an activated group of 21, 22, 23 or subgroup of characters, comprising “/Z \”, “QW”, “(Y)”, “PJ”, “:K;”, “, V!”, “?X”, the characters of an activated group of 21, 22, 23 are highlighted by modifying color, brightness or inversion of character or key images on the screen 3.

The group characters are represented along the perimeter of circle, quadrate, polygon or any other closed figure, congruent with topology of keys on the reduced keyboard, with respective characters being allocated to each key. A figure of a particular scale, which is in direct or inverse relation to an index of groups, corresponds to each group. The centers of figures coincide. In case of direct relation, the group 8 of “high-frequency” characters is arranged along the perimeter of the smallest-scale figure, group 10 of “low-frequency” characters is disposed along the perimeter of a bit-greater-scale figure, circumscribing the previous one, etc. In this case, “high-frequency” characters are arranged closer to common center for all figures, than <<low-frequency” characters, as the user's sight is focused in the center. Group 5 of rarely occurred characters, as a rule, is more numerous, and, consequently, is divided into subgroups “/Z\”, “QW”, “(Y)”, “PJ”, “:K;”, “B.”, “,V!”, “?X”. Hence, it is difficult to dispose it along the perimeter of a nested minimum-size figure. The low-frequency characters such as “/”, “Z”, “\”, “Q”, “W”, “(”, “Y”, “)”, “P”, “J”, “:”, “K”, “;”, “B”, “.”, “,”, “V”, “!”, “?”, “X” are, therefore, arranged far apart from the center. The results of character input are displayed in the field 4, which displays typed text.

Further probable alternative embodiment of the invention may have character groups spread along the perimeter of figures so that the “low-frequency” characters are disposed closer to common center of figures, and the “high-frequency” characters are put far apart from the center (not shown on drawings).

One of alternative embodiments of the invention has the lines, along which character images of an activated group might be displayed continuously or temporarily, and said lines may be nonclosed. They (images) should, however, have layout congruent with topology of keys on the reduced keyboard, which are allocated to the relevant characters. Any switchover of an activated group, in this case, causes relevant characters in the activated character group to highlight, and all remaining ones to fade by modifying color, enhancing or diminishing intensity (brightness) or inversion for color, black-and-white and monochrome displays, respectively (not shown on the drawings).

In other alternative embodiment the method may be carried out by mutually substituting the character images of various groups on the key images in such a manner that the characters of an activated group would always be arranged as close as possible to or as far as possible from the center of figures, or, in case of representation of characters along the nonclosed lines, the characters of an activated group would be spread along the top or bottom line (not shown on the drawings).

Yet further alternative embodiment of the invention, in order to simplify software requirements to carry out the claimed method and diminish overall dimensions of the device, with reference to FIG. 8, may allow displaying character images 19 on the screen only in pattern congruent with topology of keys of the reduced keyboard 1, not representing the key images proper.

As already was noted above, a provision is made in design to enable text entering, not looking at the screen, and the device may produce beep sounds, specific for each group or subgroup of characters, and even for each character. To confirm input of relevant characters for eye-sight-disabled users the invention provides for backing-up the typed character with synthesized sounds, simulating the selected alphabetic character or character title as if being pronounced, which are produced by a sound unit and a synthesizer, connected to the device or which are constituents of the latter (not shown on the drawings).

In case, if the device is supplied with a visualization/viewing means for probable display of characters on each of physical keys of the device keyboard, the character images of an activated group or subgroup are displayed on individual screens, relevant to each key, in this case characters of an activated group or subgroup are represented only, one character per each screen of the relevant key. At that, the method may be carried out on individual screens, disposed over or under each physical key of the device keyboard, and on one integral screen disposed under the whole panel of keys on the keyboard, produced from transparent material (not shown on the drawings).

Referring to FIG. 6, screen 3 may be produced in the form of a touch panel and the method may be carried out by displaying the images of all characters of an activated/current/layout of the launched language alphabet on the touch panel continuously during the whole process of characters entering, whereby display of the key and character images of all subgroups is achieved along the perimeter of closed figures, as was mentioned above, and the figures, arranged on the screen, may have different scale, but one center, and the character groups are arranged along the perimeter of figures so that the high-frequency characters are allocated closer to common center of figures, as shown on FIG. 6, and the low-frequency characters are far apart from the center. In this case the characters are touch-typed, for example, by a stylus, or any other relevant object or a finger, on areas of the screen, bearing an image of the typed character. Though, the images of keys might be omitted, similarly to alternative on FIG. 8.

The technique of text entering, referred to above, and derived mathematical calculation, confirm, that the suggested method of text entering proved to be 1.5-2 times more efficient, than both a prototype alternative described above and “Multitap” method for decoding/typing any characters and words, and is much more convenient for typing proper names, abbreviations, technical terms, keywords, abbreviations and any other words and characters of systems, not available in the vocabularies like in T9™system. Additionally, the described method allows typing words in any language, which alphabet comprises less than 50 characters. The claimed method needs no alphabetic characters to be born on physical keys of the device keyboard, for example, on mobile telephone keypad. If the characters of the relevant language are not indicated on keys of the keyboard, neither “Mul-titap” method, nor other systems such as “T9™”, nor the closest prototype in the art are useful for text entering, whereas the claimed method, as distinguished from others, enables any user to do it. The said features may be advantageously claimed for entering log-ins in cash banking terminals, for example, as passwords, more complicated than PIN-codes, or combined names, surnames, etc., as shown in reference to FIG. 7.

As distinguished from mobile telephones, the cash banking terminal have no alphabetic characters, indicated on the keys. The user is, therefore, able at present to type therein no other characters, but numeric ones. Taking advantage of the claimed input technique, disclosed with reference to FIG. 7, the characters of an activated group 14 are displayed according to layout of auxiliary keys 13 on the screen 15 of the banking terminal. As the relevant auxiliary key 13 is pressed by the user, input of character and its display on screen 15 in the typed text domain/field 16 is achieved. An activated character group is switched on/off by depressing one of the main keys 12 of the banking terminal, viz on “5” key in the preferred alternative embodiment. Having the text entering operations completed, the user may employ conventionally the cash banking terminal further by using traditional technology to receive cash through gap 11, to receive a confirmed current operation check through gap 17 and to collect a plastic card through gap 18.

Thus, the invention enables to implement the character disambiguation system for devices with the reduced keyboard. Application of claimed text input method allows entering efficiently both the alphabetic characters of the language and any punctuation characters, including even those ones specific for the language, selected by the user. Switching capability to change over between layouts of various languages at any instant of decoding allows the user to type easily multilingual texts, to insert special characters, to enter and use crack resistant passwords.

The efficiency of text input, which was justified by mathematical calculations as regards the claimed method, proved to be within the limits of 1.35-1.9 keys/character for eight major European languages, that exceeds the prototype in efficiency. Imaging of characters of the current layout on the screen in similar pattern to topology of the reduced keyboard allows keeping user's eyesight focused on the screen for typing a character, and application of the principle of character position matching in layouts of the reduced and complete keyboards allows text entering by using touch-typing system, i.e. not looking neither at the screen, nor at keys, what is extremely inconvenient while applying any analogues, described above, congruent with the invention. Neither prototype, nor other known methods and devices have characteristics indicated.

### APPLICABILITY

Applicability of the matrices and method and is under evaluation in CIS and industrially developed countries.

### REFERENCES

1. J. L. Arnott and M. Y. Javed, “Probabilistic character disambiguation for reduced keyboards using small text samples”, AAC Augmentative and Alternative Communication, 8(3), September 1992 (Decker Periodicals Inc., Ontario, Canada (ISSN 0743-4618)), pp. 215-223.
2. U.S. Pat. No. 4,650,927, 1987.
3. U.S. Pat. No. 4,674,112, 1987.
4. U.S. Pat. No. 4,918,721, 1990.
5. U.S. Pat. No. 6,011,554, 2000.
6. U.S. Pat. No. 6,307,548, 2001.
7. U.S. Pat. No. 6,307,549, 2001.
8. RU 2221268, 2004.
9. U.S. Pat. No. 4,918,721, 1990.
10. Shakhidjanyan, V. V. Solo na pishuschei mashinke. (stands for “Solo on a TypeWriter” in Russian)—Moscow: Rakurs (publisher). —1991. —p. 137.
11. Kuznetsova A. N. Mashinopis': prakticheskoe posobie. (stands for “Typewriting: Practical Manuel” in Russian)—Moscow: Ekonomika (publishers), 1997. p. 319
12. U.S. Pat. No. 6,232,892, 2001.

What is claimed:

1. A method for inputting characters into electronic computing devices, mainly mobile telephones, cash banking terminals, digital television sets, electronic palm organizers/notepads, electronic translators, comprising:
splitting characters of a selected language into groups, displaying key images of the device keyboard on the device screen in the process of text entering, with a probable unambiguous association emerging between a key image and a physical key, which the former is allocated to, on the keyboard, determining unambiguously one-to-one matching between each character of one group and each physical key on the keyboard, at each instant, by displaying an image of the group character on the key image or adjacent thereto on the screen of the device.

2. A method for inputting characters of claim 1, wherein a number of key presses to input a character from group is minimized so that one key is required to be depressed to input characters of high frequency of occurrence.

3. A method for inputting characters of claim 1, wherein characters of groups are allocated to keys on the reduced keyboard for each language congruently with topology of the character layout on the complete computer keyboard for the said language.

4. A method for inputting characters of claim 3, wherein changeover of groups is achieved by depressing an individual key on the reduced keyboard.

5. A method for inputting characters of claim 3, further comprising splitting character groups into subgroups, switching of groups and/or subgroups by depressing an individual key and modifying character images of deactivated group or subgroup to images of activated group or subgroup during changeover between group or subgroup of characters on the screen.

6. A method for inputting characters of claim 3, further comprising switching between group or subgroup achieved by depressing different keys, each one of them inducing activation of one particular group or subgroup.

7. A method for inputting characters of claim 3, further comprising admitting continuous display of characters of all groups or subgroups on the screen and highlighting characters of an activated group on the screen by adapting color or intensity (brightness) or inversion of character and/or key images when a character group or character subgroups are changed over.

8. A method for inputting characters of claim 3, wherein a continuous display of the key images and characters of all subgroups is generated along the perimeter of closed figures, congruent with topology of keys on the reduced keyboard, the figures are arranged on the screen having different scale, but one center, with character groups being arranged along the perimeter of figures so that the characters of high-frequency of occurrence are arranged closer to common center of figures, and the characters of low-frequency of occurrence being arranged far apart from the center.

9. A method for inputting characters of claim 8, wherein the character groups are arranged along the perimeter of figures in such a way that the characters of low frequency of occurrence are arranged closer to the common center of figures, and the characters of high frequency of occurrence are arranged far apart from the center.

10. A method for inputting characters of claim 1, wherein the character groups are arranged for a continuous or temporary representation on the screen along the nonclosed lines, congruent with topology of keys on the reduced keyboard.

11. A method for inputting characters of claim 8, further comprising mutual substituting the character images of various groups by key images in such way that the characters of an activated group are arranged as close to or as far from the center of figures as possible, or, in case of displaying characters along nonclosed lines, the characters of an activated group are arranged along the top or bottom line.

12. A method for inputting characters of claim 3, further admitting representation of character images congruent with topology of keys on the reduced keyboard only, not displaying an image of keys proper.

13. A method for inputting characters of claim 3, wherein switchover of an activated group or subgroup is followed by a beep sound, which is generated by a sound unit connected to the device or which is a constituent of the latter.

14. A method for inputting characters of claim 3, wherein each group or subgroup has a unique beep sound of a particular keynote (tone) and/or a loudness level allocated to, which beep sound is generated at instant a relevant group or subgroup is selected.

15. A method for inputting characters of claim 3, wherein adding of an input character to a typed text is backed up by a beep sound of a particular tone or by synthesized sounds, adequate to a character as if being pronounced, which are generated by a sound unit and synthesizer connected to the device or which are constituents of the latter.

16. A method for inputting characters of claim 3, wherein character images of an activated group or subgroup are displayed on individual screens, congruent to each key, whereby characters of an activated group or subgroup are displayed only, one character per each screen, congruent to a relevant key.

17. A method for inputting characters of claim 3, wherein character images of an activated group or subgroup are displayed on individual screens, congruent to each key, and arranged under transparent keys of the reduced keyboard, whereby characters of an activated group or subgroup are displayed only, one character per each area of the screen under the relevant key.

18. A method for inputting characters of claim 3, further comprising generating representation of images of all characters of a current layout permanently on the touch panel during the whole process of character input, displaying key images and characters of all subgroups along the perimeter of closed figures, arranging figures on the screen, the former having different scale, but one center, and arranging character groups along the perimeter of figures in such a way, that the characters of high-frequency of occurrence are arranged closer to the common center of figures, and the characters of low-frequency of occurrence are far apart from the center, and inputting characters not by switching the groups, but by touching a relevant area of the screen, having an image of the typed character.

19. A matrix for inputting characters into electronic computing devices according to claim 1, mainly into mobile telephones, cash banking terminals, digital television sets, electronic palm organizers/notepads, electronic translators, comprising visual line representation of alphabetic and numeric characters of a text message of the selected language on the screen of an electronic computing device, wherein the characters of the selected language are arranged on the screen in the form of groups, with a probable unambiguous association emerging between a virtual key image and a physical key on the keyboard allocated thereto, whereby one-to-one matching between each character of one group and each physical key on the keyboard is determined at each instant of performance by displaying an image of the group character on the virtual key image or adjacent thereto on the screen of the device.

20. A method for inputting characters of claim 2, wherein characters of groups are allocated to keys on the reduced keyboard for each language congruently with topology of the character layout on the complete computer keyboard for the said language.

21. A method for inputting characters of claim 2, wherein the character groups are arranged for a continuous or temporary representation on the screen along the nonclosed lines, congruent with topology of keys on the reduced keyboard.

22. A method for inputting characters of claim 3, wherein the character groups are arranged for a continuous or temporary representation on the screen along the nonclosed lines, congruent with topology of keys on the reduced keyboard.

23. A method for inputting characters of claim 4, wherein the character groups are arranged for a continuous or temporary representation on the screen along the nonclosed lines, congruent with topology of keys on the reduced keyboard.

24. A method for inputting characters of claim 5, wherein the character groups are arranged for a continuous or temporary representation on the screen along the nonclosed lines, congruent with topology of keys on the reduced keyboard.

25. A method for inputting characters of claim 6, wherein the character groups are arranged for a continuous or temporary representation on the screen along the nonclosed lines, congruent with topology of keys on the reduced keyboard.

26. A method for inputting characters of claim 7, wherein the character groups are arranged for a continuous or temporary representation on the screen along the nonclosed lines, congruent with topology of keys on the reduced keyboard.
